(19) United States
(12) Patent Application Publication
(10) Pub. No.: US 2016/0050235 A1
(43) Pub. Date: Feb. 18, 2016

(54) Flexible Server Architecture With Ability To Dynamically Change Gateway Communication Channels

(71) Applicant: Entefy Inc., Campbell, CA (US)

(72) Inventors: Alston Ghafourifar, Los Altos Hills, CA (US); Philip Nathan Greenberg, Santa Clara, CA (US)

(21) Appl. No.: 14/461,967

(22) Filed: Aug. 18, 2014

(51) Int. Cl. H04L 29/06

(52) U.S. Cl. CPC H04L 65/1033; H04L 67/42

(57) ABSTRACT

This disclosure relates to systems, methods, and computer readable media for allowing users or systems to change the gateway for particular channels of communication in an on-demand fashion, i.e., with the “flick of a switch.” More particularly, but not by way of limitation, this disclosure relates to systems, methods, and computer readable media which, by default, directly interact with each channel of communication and then funnel messages to the appropriate connected clients. Moreover, according to the techniques disclosed herein, each user may choose which device becomes the entry and/or exit point (i.e., gateway) for each communication channel, and that device may instantly become the “master” for those messages arriving via that communication channel. The improved centralized server then knows where to automatically route such messages for each communication channel. Also disclosed herein is a novel “common message object” format for storing and searching through messages in an improved fashion.

### TECHNICAL FIELD

This disclosure relates generally to systems, methods, and computer readable media for flexible and dynamic server architectures, e.g., for communication servers.

### BACKGROUND

The proliferation of personal computing devices in recent years, especially mobile personal computing devices, combined with a growth in the number of widely-used communications formats (e.g., text, voice, video, image) and protocols (e.g., SMTP, IMAP/POP, SMS/MMS, XMPP, YMSG, etc.) has led to a communications experience that many users find fragmented and/or difficult to manage, while still maintaining a desired level of privacy and flexibility.

With current communications technologies, communications servers typically have a “static” architecture, that is, the incoming and outgoing gateway for a particular channel of communication tends to remain the same over time. For example, a user's personal emails (e.g., those going through a third party webmail server) may, by default, always be pulled from such third party's webmail server, sent through a centralized communication server, and then synced to the user's client device(s). However, in some instances, the user may desire the flexibility to change the incoming gateway for the particular channel of communication. For example, the user may desire his or her personal emails to first be pulled directly to a client device, where they may be encrypted prior to being synchronized with the aforementioned centralized communication server and pushed to the user's other client devices. In such a situation, the centralized communication server would not be able to decrypt or understand the messages received or sent for this particular communication channel, thus providing additional privacy to the user—while still being able to be used as the “gateway,” i.e., entry and exit point, for other channels of communication, such as work emails or voice messages.

Another limitation with current communications technologies relates to the disparate manners in which communications of different formats (and sent via different communications protocols) are handled by centralized communications servers. For example, an email object, may need to have a properly-packaged header including, e.g., the To:, From:, Subject: information, etc., before being sent to the corresponding third party webmail server. With the proliferation of communications formats, this may place a significant burden on communications servers attempting to pass messages of different formats (and sent via different communications protocols) between and among a plurality of client devices.

Thus, according to some embodiments described herein, an improved centralized server architecture is disclosed, which provides a “unified API” (Application Programming Interface) approach for interacting with every major form of communication and every major digital file type (e.g., .doc, .pdf, .png, .xlsx, .zip, etc.). Such an improved centralized server, which may, e.g., take the form of a centralized communication server, may effectively act as an I/O (input/out) hub, which directly connects to each channel of communication individually—while maintaining persistent connection(s) to each connected client, which clients may be run on a variety of devices and OS's (operating systems), including mobile computing devices, wearables, and the like. In other embodiments, the centralized server may take the form of a file server, or other form of input/output-based server system.

Such an improved centralized server, in effect, forms an additional layer of abstraction on top of the world's major communication APIs. To deal with the variety of disparate communications formats and protocols handled by such an improved centralized server, once a message enters the centralized server ecosystem, it may be converted to a so-called “common message object” for subsequent communication, search, and storage. By forming this additional abstraction layer around messages, the improved centralized server may treat incoming messages agnostically after entering the system, and then translate such messages into any desired protocol, e.g., according to a set of predefined protocol translation rules, before transmitting the messages to the appropriate end points. Further, by being able to rapidly and flexibly change the architecture of the improved centralized server, users may be placed in greater control over their data and devices—potentially leading to increases in privacy, security, and speed in communications.

The subject matter of the present disclosure is directed to overcoming, or at least reducing the effects of, one or more of the problems set forth above. To address these and other issues, techniques that enable flexible and dynamic server architectures are described herein.

### BRIEF DESCRIPTION OF THE DRAWINGS

FIG. 1A is a diagram illustrating a server gateway network architecture infrastructure, according to one or more disclosed embodiments.

FIG. 1B is a flowchart illustrating a process for “server gateway” message synchronization, according to one or more disclosed embodiments.

FIG. 2 is a diagram illustrating a hybrid-gateway network architecture infrastructure, according to one or more disclosed embodiments.

FIG. 3 is a diagram illustrating a client-gateway network architecture infrastructure, according to one or more disclosed embodiments.

FIG. 4 is a diagram illustrating a free-form hybrid-gateway network architecture infrastructure, according to one or more disclosed embodiments.

FIG. 5 is a diagram illustrating a dynamic-gateway network architecture infrastructure, according to one or more disclosed embodiments.

FIG. 6 is a diagram illustrating a peer-to-peer network architecture infrastructure, according to one or more disclosed embodiments.

FIG. 7 is a table illustrating various properties and tradeoffs of the various network architecture infrastructures disclosed herein.

FIG. 8A is a block diagram illustrating a computer which could be used to execute the techniques described herein according to one or more of disclosed embodiments.

FIG. 8B is a block diagram illustrating a processor core, which may reside on a computer according to one or more of disclosed embodiments.

### DETAILED DESCRIPTION

Disclosed are systems, methods, and computer readable media for allowing users or systems to change the incoming and outgoing gateways for particular channels of communication in an on-demand fashion, i.e., with the “flick of a switch.” More particularly, but not by way of limitation, this disclosure relates to systems, methods, and computer readable media which, by default, directly interact with each channel of communication and then funnel messages to the appropriate connected clients. Moreover, according to the techniques disclosed herein, each user may choose which device becomes the entry and/or exit point (i.e., gateway) for each communication channel, and that device may instantly become the “master” for those messages arriving via that communication channel. The improved centralized server then knows where to automatically route such messages for each communication channel.

In addition, the improved centralized communication system according to some embodiments may elect to intelligently “flick the switch” to change the entry and/or exit point for a particular communication channel on behalf of a user. For example, while travelling, users may need to reauthorize their credentials when using a third party webmail service (e.g., because of IP address changes). The improved centralized communication system's server will be able to automatically detect such an issue and reauthorize the third party communication channel through the centralized server (which provides a stable IP address). Once reauthorized, the client device may then reconnect to the third party webmail service communication channel. Another example involves the opposite case, i.e., if the user has a third party communication channel that the centralized server can't authorize, the system may instantly try to connect through the client instead. Yet another example of a time when the centralized communication system's server could intelligently and dynamically change the entry and/or exit point for a particular communication channel would be when the server is overloaded and the system automatically or manually “flicks the switch” to reduce the load on the server and distribute the load to the clients. As will be more fully appreciated, architecturally, this system provides for dynamic syncing between client and server, as well as discretionary content flow and sync management.

Common Message Objects (CMOs)

Another innovation provided herein is the use of so-called “common message objects” (CMOs) by the flexible and dynamic server architecture system to be described herein. The CMO may be used to unify all types of “communication events,” file object, or other data object into a single kind of data object. According to some embodiments, the CMO comprises a limited number of attributes, such as: “Message Type”; “Channel Association”; “Sender/Recipient Association”; and metadata. The “Message Type” attribute may provide the server with an indication of the format of the particular message, e.g., email message, SMS message, etc. The “Channel Association” attribute may be used to provide the server with an indication of what protocol the CMO is to be sent via. For example, the Channel Association attribute could specify a particular third party email server, social network server, instant messaging server, Exchange message server, or the like. The “Sender/Recipient Association” attribute may be utilized by the server to keep track of which party(ies) each message involves, i.e., who the message belongs to and who it is being sent to. These attributes may be expandable, depending on the needs of a particular implementation. For example, each CMO may be tagged with information for both the sender and recipient, including, at a minimum, an ID and transmission protocol for the relevant communication channel at both the incoming and outgoing levels. According to some embodiments, the various attributes of the CMO determine how the centralized server will format a message object on the outgoing end.

According to some embodiments, the CMO framework allows the centralized server to handle generic JavaScript Object Notation (JSON) objects, rather than specific messages types, such as email messages or SMS messages. JSON is a lightweight data-interchange format that is easy for humans to read and write and easy for machines to parse and generate. JSON is based on a subset of the JavaScript Programming Language that uses a text format that is completely language-independent—but uses conventions that are familiar to programmers of the C-family of languages, including C, C++, C#, Java, JavaScript, Perl, Python, and many others. For example, a JSON object is an unordered set of name/value pairs. An object begins with a left brace and ends with a right brace. Each name is followed by a colon, and the name/value pairs are separated by commas. These properties make JSON an ideal data-interchange language.

By leveraging generic JSON objects, the centralized server does not have to know how to specifically handle particular messaging formats, such as email messages or SMS messages. It simply handles a CMO JSON object that is “tagged” as an email. Then, just before sending the CMO to the appropriate location, e.g., a Google third party webmail server, the centralized server may convert the CMO to a Gmail-compatible email object. This enables the system to treat all messages the same for the purposes of search, storage, and transport throughout the system. For example, Email and XMPP use MIME and XML message formats, respectively, and, by leveraging the CMOs, the system does not have to deal with those message formats individually within the system—only JSON. Also, the “translations” into MIME are standard, so they do not have to be stored within the CMO; instead, they may be stored within the IMAP service portion of the system (i.e., in only one place). Thus, the centralized server needs only to inspect the JSON objects and then follow the rules about how to package the message object. This flexibility allows the same content to be read or transmitted to the user in a completely different format at an arbitrary time in the future, e.g., as an SMS text message in six months' time.

As may now be more fully appreciated, the flexible and dynamic server architecture system may now essentially function as a simple router, i.e., processing packets of a common object type according to a set of predefined rules.

Event-Driven Architecture

According to some embodiments, the flexible and dynamic server architecture system may be largely “event driven,” meaning that it simply reacts as a router, processing and redirecting incoming CMOs to the appropriate destinations as they occur. As such, the architecture may very rapidly and intelligently change the entry and/or exit point for a particular communication channel on behalf of a user. For example, if a user logs into a third party webmail server, the centralized server may receive access to the third party system directly, in which case it would have no problem synchronizing messages for the user with respect to that particular webmail server. However, in the case of an Exchange Server, the Exchange Server may look for the appropriate hardware token and/or certificate on a client before passing messages to such a client. According to some embodiments described herein, a user may declare his or her authorized device (e.g., his or her work-provided laptop or desktop device) as the entry and/or exit point for the communication channel corresponding to his or her Exchange server. At that point, the centralized server may receive and forward the encrypted messages received via the Exchange server to the user's client devices, but will not itself be able to read such messages—since the centralized server will not hold the key needed to decrypt the content.

In other embodiments, the flexible and dynamic server may comprise a “revolving switch”-style architecture. For example, in the case of users travelling abroad, it may become necessary for a user to reauthorize his or her credentials when using a third party webmail service. However, this may be difficult due to the new and changing IP addresses the user's devices may be utilizing abroad. Thus, according to such embodiments, the flexible and dynamic server may look to a user's work-provided laptop or desktop device and attempt to use that device as the entry and/or exit point for the communication channel corresponding to that particular third party webmail service. If the user's work-provided laptop or desktop device is down, the flexible and dynamic server may next look to the user's phone, and so on and so forth through the user's various client devices or the centralized server until finding a device that may be used as the gateway for that communication channel (it should be noted that the usable device may also be used as an extension of—or part of—the centralized server itself). Such a “revolving switch” architecture is made possible by the flexible and dynamic server maintaining a list of every authorized device for users of the centralized communication system.

Socket-Driven Architecture

According to some further embodiments, the flexible and dynamic server architecture may also be “socket-driven,” meaning that it utilizes sockets, e.g., Transmission Control Protocol (TCP) sockets, in a unique way to provide near latency-free communication routing. In particular, and according to some embodiments, the flexible and dynamic server with socket-driven architecture treats clients as extensions of the event-driven server. In such embodiments, the entire server architecture may comprise modular services connected together via sockets, where the clients are just another service that happens to have a user interface (UI). In some embodiments, the WebSocket protocol is used to implement the socket-driven server architecture (though such a choice is not strictly necessary, as different socket protocols may be employed for a given implementation, such as the User Datagram Protocol (UDP) or Raw IP sockets). WebSocket is a protocol providing an abstraction layer making full-duplex communications channels over a single TCP connection easy. The WebSocket protocol may make greater interaction possible between a browser (or other client) and a webserver (or other server) by facilitating live content and the creation of real-time content. This improved interaction is made possible by providing a standardized way for the server to send content to the browser (or other client) without first being solicited by the client. The WebSocket protocol also allows for messages to be passed back and forth between client and server, while keeping the connection open. In this way, a bi-directional ongoing conversation can take place between a client and the server.

Use of the socket-driven server architecture in certain embodiments described herein allows the flexible and dynamic server architecture system to rapidly change the gateways for particular communications channels. The use of sockets may also provide for increased speed in the routing of messages by the centralized server to the various client devices of users.

Unified Communication API

According to some embodiments, the techniques disclosed herein provide for a “unified communications API” for interacting with every major communication protocol (e.g., SMTP, IMAP/POP, SMS/MMS, XMPP, YMSG, etc.) and every major digital file type (e.g., .doc, .pdf, .png, .xlsx, .zip, etc.). This allows any type of client device, e.g., a smartphone, smart watch, or other connected and capable device, to connect to the centralized server with a single command, while allowing the server to handle everything else about the communication interaction. Further, by employing the CMO model, client devices do not need to do anything particular to initialize communication channels with the centralized server. They simply open the necessary sockets and allow the centralized server to carry the burden of message packaging and routing. Files of various types, e.g., audio and video files, may be stored in their original formats in a centralized master database or “source of truth,” so that they may be accessed, converted, routed, etc. at the appropriate time by the centralized communications server. For encrypted objects stored at the centralized communications server, there may be limited fields upon which the system is able to search for the file, such as file name, file length, etc. Clients may also generate descriptive tags to attach to the encrypted objects, so that the centralized server will also be able to perform limited content-based searching at a later time. The unified and universal nature of the messaging infrastructure proposed herein may lead to many significant API developments, and may be employed in many different fields where the client devices and/or locations at any given point in time are diverse and varied, such as emergency notification services, Amber Alert services, and others.

As may now be more fully appreciated, the clients in certain embodiments of the flexible and dynamic centralized server architecture described herein are not “clients” in the typical sense. Instead, the clients may actually be thought of as “extensions” to the centralized server itself, wherein the entire centralized server system utilizes modular pieces referred to herein as “services,” which may all be interconnected to one another through sockets. In some embodiments, e.g., WebSockets are used to extend these same services from the centralized server to the clients. For example, an IMAP client service on the centralized server could also be loaded onto any number of clients—and the centralized server may then keep track of which client is “valid” for any given communication channel, thus enabling the aforementioned flexible and dynamic “switching” architecture.

Flexible and Dynamic Server Architecture Infrastructure Examples

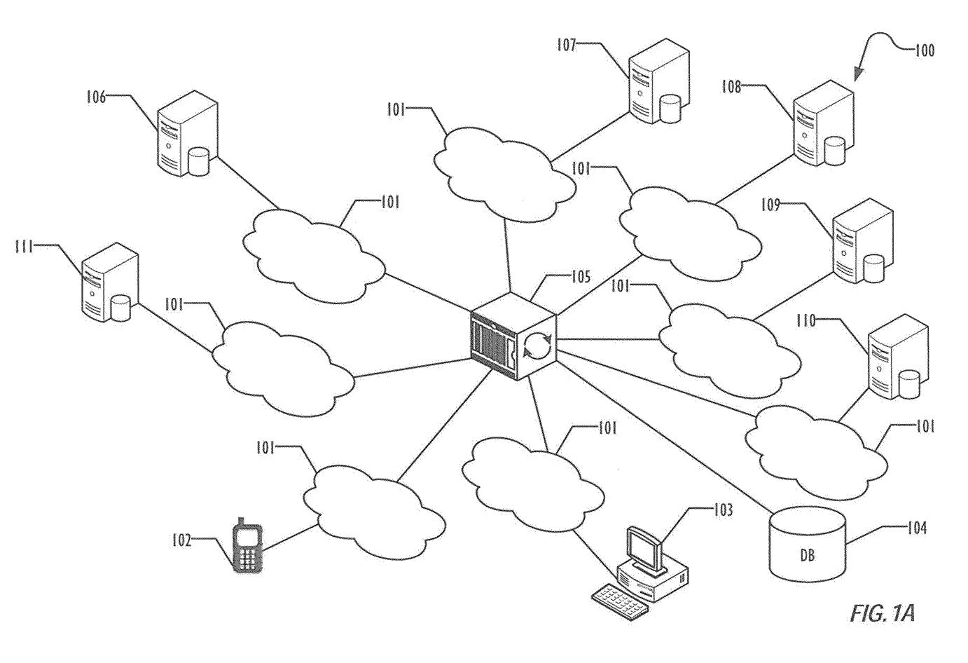

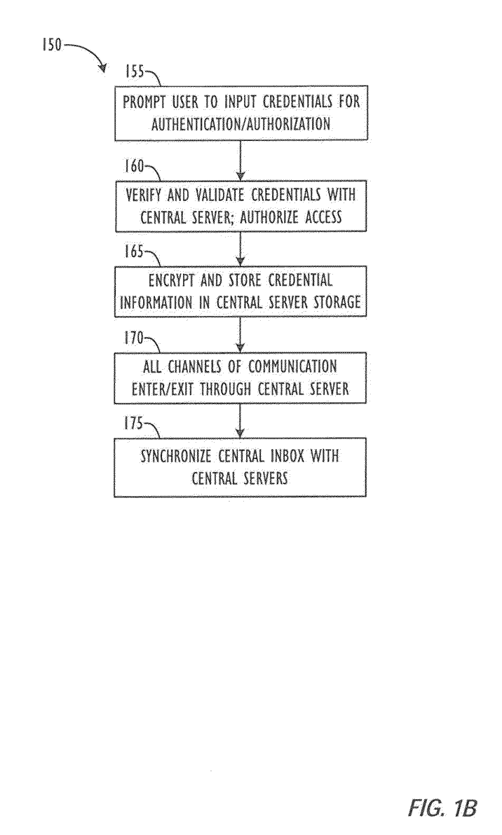

Referring now to FIG. 1A, a “server-gateway” network architecture infrastructure 100 is shown schematically. Infrastructure 100 contains computer networks 101. Computer networks 101 include many different types of computer networks available today, such as the Internet, a corporate network, or a Local Area Network (LAN). Each of these networks can contain wired or wireless devices and operate using any number of network protocols (e.g., TCP/IP). Networks 101 may be connected to various gateways and routers, connecting various machines to one another, represented, e.g., by sync server 105, end user computers 103, mobile phones 102, and computer servers 106-111. In some embodiments, end user computers 103 may not be capable of receiving SMS text messages, whereas mobile phones 102 are capable of receiving SMS text messages. Also shown in infrastructure 100 is a cellular network 101 for use with mobile communication devices. As is known in the art, mobile cellular networks support mobile phones and many other types of devices (e.g., tablet computers not shown). Mobile devices in the infrastructure 100 are illustrated as mobile phone 102. Sync server 105, in connection with database(s) 104, may serve as the central “brains” and data repository, respectively, for the flexible and dynamic server architecture system to be described herein. In the server-gateway network architecture infrastructure 100 of FIG. 1A, centralized sync server 105 may be responsible for querying and obtaining all the messages from the various communication sources for individual users of the system and keeping the messages for a particular user of the system synchronized with the data on the various third party servers that the system is in communication with. Database(s) 104 may be used to store local copies of messages sent and received by users of the system, as well as individual documents associated with a particular user, which may or may not also be associated with particular communications of the users. As such, the database portion allotted to a particular user will contain a record of all communications in any form to and from the user.

Server 106 in the server-gateway network architecture infrastructure 100 of FIG. 1A represents a third party email server (e.g., a GOOGLE® or YAHOO! ® email server). (GOOGLE is a registered service mark of Google Inc. YAHOO! is a registered service mark of Yahoo! Inc.) Third party email server 106 (referred to herein as “Channel 1”) may be periodically pinged by sync server 105 to determine whether particular users of the flexible and dynamic server architecture system described herein have received any new email messages via the particular third-party email services. Server 107 (referred to herein as “Channel 2”) represents a third party social network server (e.g., a FACEBOOK® or TWITTER® server). (FACEBOOK is a registered trademark of Facebook, Inc. TWITTER is a registered service mark of Twitter, Inc.) Third party social network server 107 may also be periodically pinged by sync server 105 to determine whether particular users of the flexible and dynamic server architecture system described herein have received any new social network messages via the particular third-party social network services. It is to be understood that, in a “push-based” system, third party servers may push notifications to sync server 105 directly, thus eliminating the need for sync server 105 to periodically ping the third party servers.

Servers 108 and 109 (referred to herein as “Channel 3” and “Channel 4,” respectively) represent third party instant message servers (e.g., a YAHOO! ® Messenger or AOL® Instant Messaging server). (AOL is a registered service mark of AOL Inc.) Third party instant messaging servers 108 and 109 may also be periodically pinged by sync server 105 to determine whether particular users of the flexible and dynamic server architecture system described herein have received any new instant messages via the particular third-party instant messaging services. Server 110 (referred to herein as “Channel 5”) represents a third party Exchange Server, e.g., a server managing a user's business email account (referred to herein as “Channel 5”). Server 111 (referred to herein as “Channel 6”) represents a cellular service provider's server. Such servers may be used to manage the sending and receiving of messages (e.g., email or SMS text messages) to users of mobile devices on the provider's cellular network. Cellular service provider servers may also be used: 1) to provide geo-fencing for location and movement determination; 2) for data transference; and/or 3) for live telephony (i.e., actually answering and making phone calls with a user's client device). In situations where two ‘on-network’ users are communicating with one another via the flexible and dynamic server architecture system itself, such communications may occur entirely via sync server 105, and third party servers 106-111 may not need to be contacted.

As may now be more fully appreciated, the “server-gateway” network architecture infrastructure 100 shown in FIG. 1A provides certain advantages and disadvantages in certain communication situations. For example, because all channels of communication for a give user enter/exit through the centralized server 105, the “server-gateway” network architecture configuration provides the fastest possible synching and most accurate searching/threading of the user's messages since all the information is known to the centralized server. Some users may consider this configuration to lack in security, since the centralized server would have access to unencrypted versions of the user's messages.

Referring now to FIG. 1B, a process 150 for “server-gateway” message synchronization is shown in flowchart form. First, the process may begin by prompting the user to input his or her credentials for authentication and authorization with the centralized communication system (Step 155). Next, the centralized server may verify and validate the user's credentials with the server and authorize the user's access (Step 160). Next, the centralized system may encrypt and store the user's credential information the storage at the centralized server (Step 165). Once the user has been initialized in this manner, all channels of communication for the user may begin to enter and exit through the central server, according to the “server-gateway” message synchronization configuration illustrated in FIG. 1A and being described here with reference to FIG. 1B. Finally, the user's centralized inbox (e.g., messaging feed) on the user's various client devices may be synchronized with the central server (Step 175).

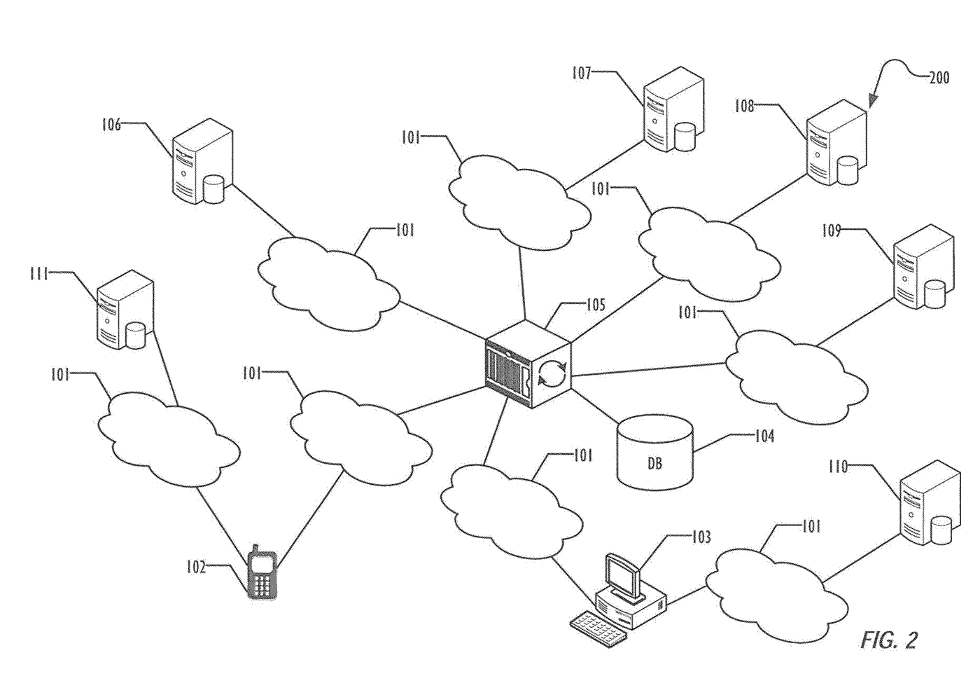

Referring now to FIG. 2, a “hybrid-gateway” network architecture infrastructure 200 is shown schematically. Similar to infrastructure 100 shown in FIG. 1A, infrastructure 200 contains computer networks 101. Computer networks 101 may again include many different types of computer networks available today, such as the Internet, a corporate network, or a Local Area Network (LAN). However, unlike the server-centric infrastructure 100 shown in FIG. 1A, infrastructure 200 is a hybrid-gateway architecture, meaning that it may use client and/or server gateways for particular communication channels. Thus, individual client devices, such as end user computers 103 and mobile phones 102 may be used to as the gateway entry and/or exit points for certain communication channels. For example, as shown in FIG. 2, mobile phone 102 serves as the gateway for Cellular Service Provider Server 111 (“Channel 6”) and end user computer 103 serves as the gateway for third party Exchange Server 110 (“Channel 5”). Meanwhile, the central sync server 105 may serve as the gateways for certain communication channels (e.g., third party servers 106-109, which correspond to communications Channels 1-4). Such a system has the benefit that, for communication channels using a client gateway, there may be less delay in receiving messages than in a system where the central server is responsible for authorizing and pulling communications for many users simultaneously. Further, communications received via a client-entry channel may be client-side encrypted, lending itself well to a true, “zero knowledge” privacy enforcement scheme. Meanwhile, according to a hybrid-gateway infrastructure, the user maintains the flexibility to maintain some communication channels as server entry and/or exit point channels, potentially providing for faster synchronizing speeds and more reliable connections to third party services (e.g., when compared to client gateways that are mobile devices reliant on the availability of mobile communications networks for the transmission of data). As discussed above, a hybrid infrastructure may also be advantageous because of the ability to perform authorization of third party services partially based on Internet Protocol (IP). For example, if the client is a mobile phone, it will have a drastically different IP address when the user is travelling abroad. When the server is the gateway, however, the IP will stay constant, even when the user is travelling abroad.

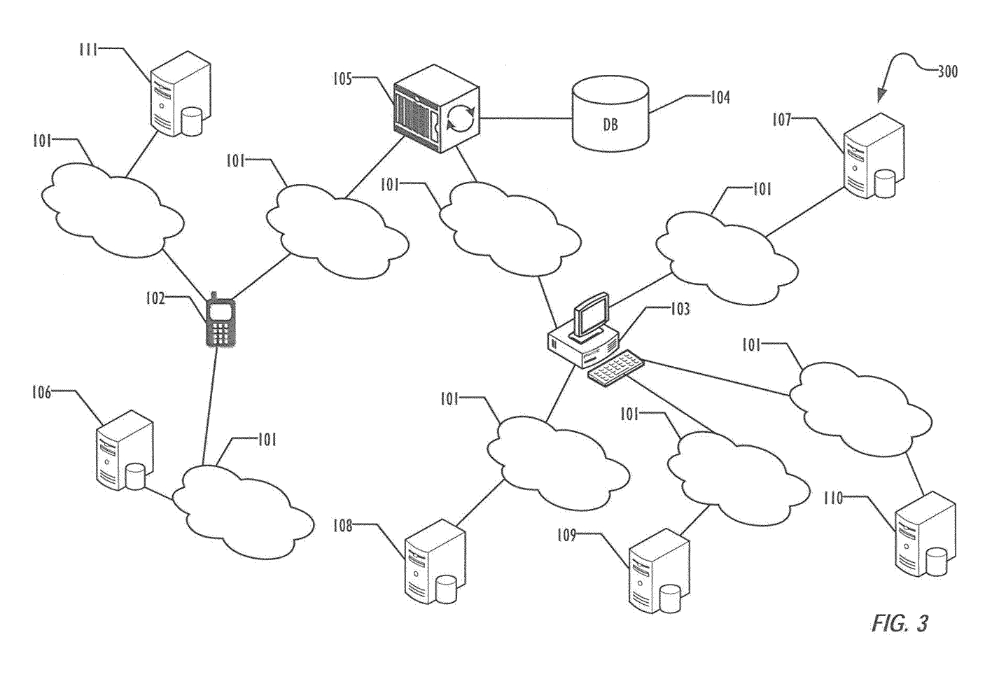

Referring now to FIG. 3, a “client-gateway” network architecture infrastructure 300 is shown schematically. Similar to infrastructure 100 shown in FIG. 1A and 2, infrastructure 150 contains computer networks 101. Computer networks 101 may again include many different types of computer networks available today, such as the Internet, a corporate network, or a Local Area Network (LAN). However, unlike the server-centric infrastructure 100 shown in FIG. 1A, infrastructure 300 is a client-centric architecture. Thus, individual client devices, such as end user computers 103 and mobile phones 102 may be used to query the various third party computer servers 106-111 to retrieve the various third party email, IM, social network, Exchange, cellular, and other messages for the user of the client device. Such a system has the benefit that there may be less delay in receiving messages than in a system where a central server is responsible for authorizing and pulling communications for many users simultaneously. Also, a client-gateway system may place less storage and processing responsibilities on the central multi-protocol, multi-format communication composition and inbox feed system's server computers since the various tasks may be distributed over a large number of client devices. Further, a client-gateway system may lend itself well to a true, “zero knowledge” privacy enforcement scheme. In infrastructure 300, the client devices may also be connected via the network to the central sync server 105 and database 104. For example, central sync server 105 and database 104 may be used by the client devices to reduce the amount of storage space needed on-board the client devices to store communications-related content and/or to keep all of a user's devices synchronized with the latest communication-related information and content related to the user. It is to be understood that, in a “push-based” system, third party servers may push notifications to end user computers 102 and mobile phones 103 directly, thus eliminating the need for these devices to periodically ping the third party servers.

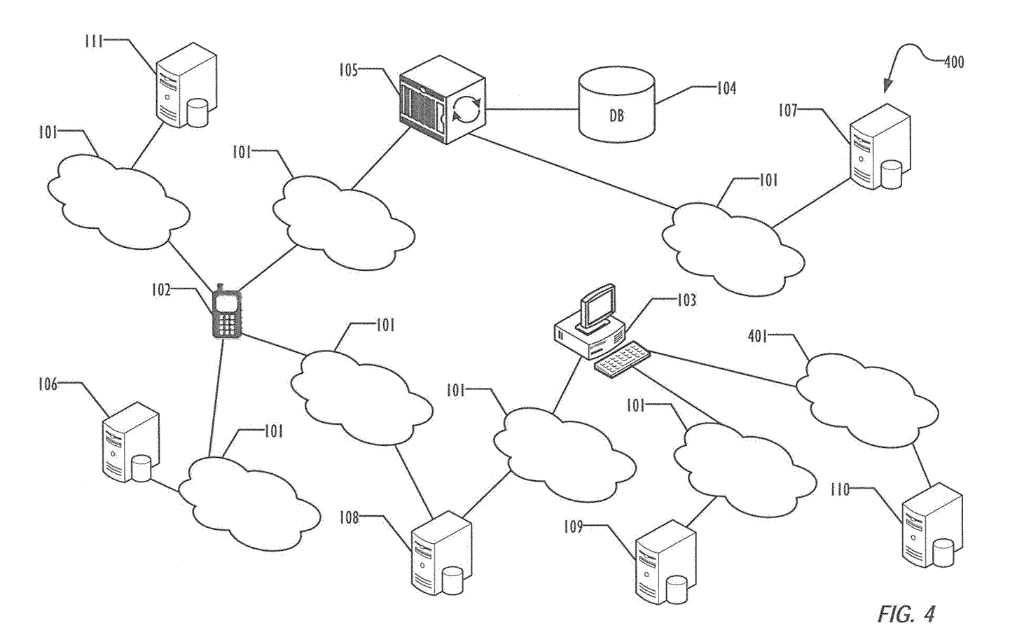

Referring now to FIG. 4, a “free-form hybrid-gateway” network architecture infrastructure 400 is shown schematically. Infrastructure 400 represents a true hybrid gateway approach, showing the ability for client devices that are disconnected from the central sync server 105 (e.g., end user computer 103) to still be able to send and receive messages. For example, a particular user may want to be able to access certain channels of communication on only one particular device, such that there is only one potential client-side ‘point of failure’ (e.g., if the device is lost, destroyed, or stolen, etc.). However, as shown in FIG. 4, the communication channel represented by third party instant message server 108 is still connected to all client devices (i.e., 102 and 103), but it is directly connected to both clients. In addition, multiple clients may connect to the same communication channel if that channel supports it (e.g., IMAP, XMPP, etc.). While the speed for such a network architecture may be lower than full server-gateway architecture systems, a high level of security may be achieved through client side encryption.

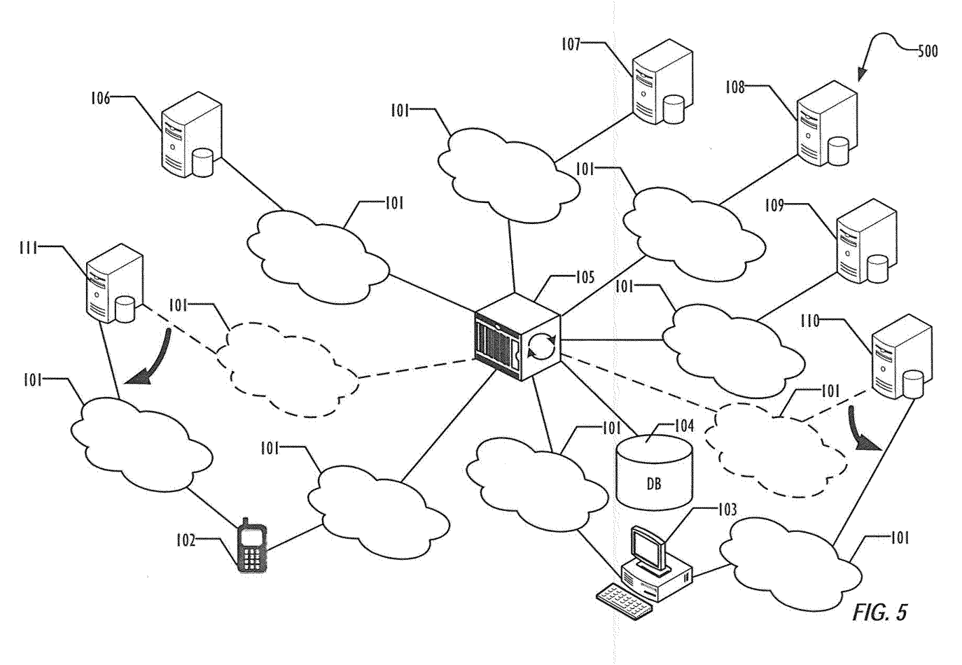

Referring now to FIG. 5, a “dynamic-gateway” network architecture infrastructure 500 is shown schematically. Infrastructure 500 represents a network architecture approach, whereby the incoming gateway for a particular communication channel may change dynamically over time. As discussed above, it may be useful to dynamically change the entry and/or exit point for a particular communication channel for several reasons, such as connectivity or the inability of a device to maintain a static and/or trusted IP address, e.g., due to travel. As illustrated in FIG. 5, the dashed line network cloud 101 connecting Cellular Service Provider Server 111 (“Channel 6”) to sync server 105 represents the fact that Channel 6 was previously a server-gateway communication channel. However, as illustrated by the thick black arrow, Channel 6 now connects to sync server 105 via mobile phone 102, making it a client-gateway communication channel. Likewise, the dashed line network cloud 101 connecting Cellular third party Exchange Server 110 (“Channel 5”) to sync server 105 represents the fact that Channel 5 was previously a server-gateway communication channel. However, as illustrated by the thick black arrow, Channel 5 now connects to sync server 105 via end user computer 103, making it a client-gateway communication channel. As may be appreciated, with a dynamic-gateway network architecture infrastructure, any or all communications channels may potentially change from being server-gateway to client-gateway and back again, providing the greatest amount of flexibility to the communications network. For example, if a particular client device is low on battery, the system may move to a “server-gateway” architecture approach in order to reduce the workload on the client device. Likewise, if the centralized server becomes overloaded, it could automatically or manually “flick the switch” to distribute the channel's connectivity to the client, in order to reduce the workload on the centralized server.

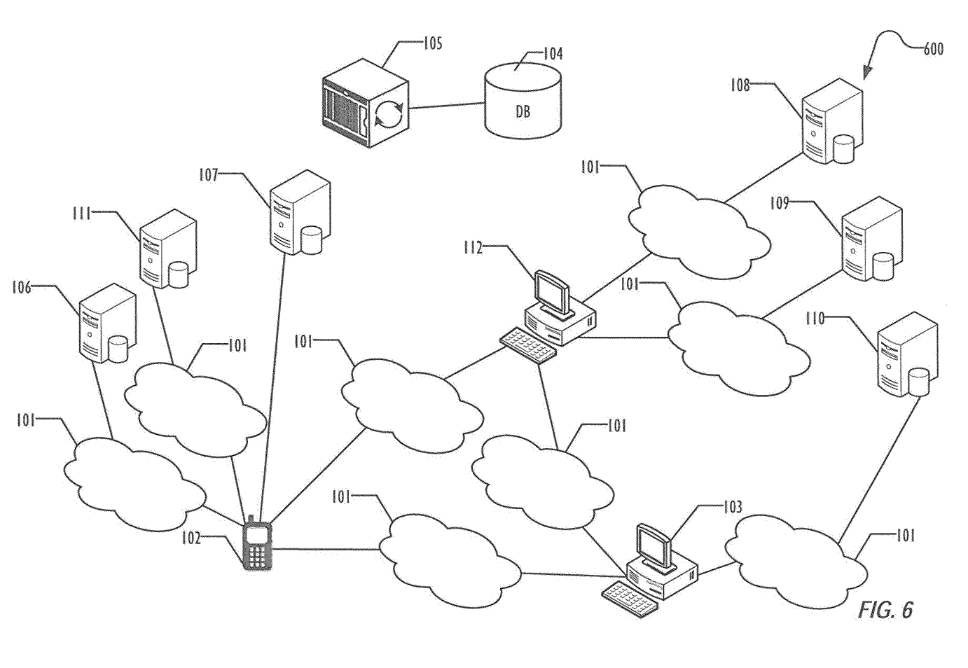

Referring now to FIG. 6, a “peer-to-peer” (P2P) network architecture infrastructure 600 is shown schematically. Infrastructure 600 represents a network architecture approach, whereby the sync server 105 may be bypassed entirely. According to such embodiments, it may be useful to bypass the sync server 105 for several reasons, such as for increased privacy (i.e., the sync server will not be privy to any communications passed exclusively through the P2P network) and to avoid situations where the central sync server is offline or experiencing limited bandwidth availability. Potential drawbacks of such embodiments include decreased sync speed and a limited ability of the sync server to provide searching services across peer devices, as well as increased battery draw and network bandwidth usage by the devices involved in the P2P network. As illustrated in FIG. 6, end user computer 103 may communicate with a second end user computer 112 directly through network cloud 101, e.g., by relaying messages from any of third party computer servers 106, 107, 110, or, 111—all without involving sync server 105. Likewise, second end user computer 112 may relay messages from third party computer servers 108 or 109 to end user computer 103 or mobile phone 102 without involving sync server 105.

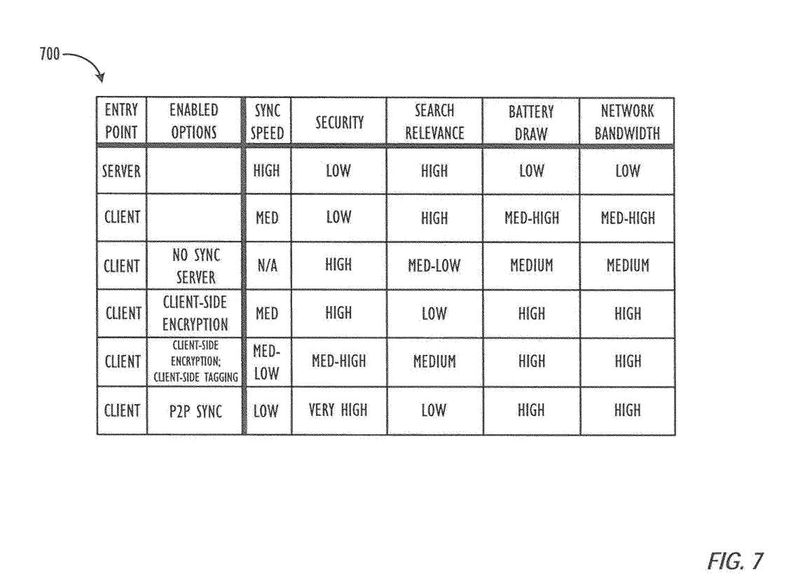

Referring now to FIG. 7, a table 700 illustrating various properties and tradeoffs of the various network architecture infrastructures disclosed herein is shown. Table 700 compares channel entry and exit point option in terms of: sync speed; security; search relevance; battery draw on the client device; and network bandwidth usage. As mentioned above, network architecture infrastructural approaches that utilize client-side encryption provide for greater security because the central server is unable to parse the content of the encrypted messages. A drawback to this approach, however, is that searching relevance is limited because the centralized server does not know the contents of the messages that it is searching among. This limitation may be ameliorated somewhat via the use of client-side tagging, which involves client devices intentionally choosing tags based on the content or metadata of a given message to be encrypted and sent along with the message in a manner that may be decrypted and interpreted by the centralized server to provide a modicum of searching functionality. As will be understood, network architecture infrastructural approaches that utilize client gateways will be more battery draw-intensive and network bandwidth-intensive than approaches that rely on the centralized server to do the “heavy lifting” of message routing.

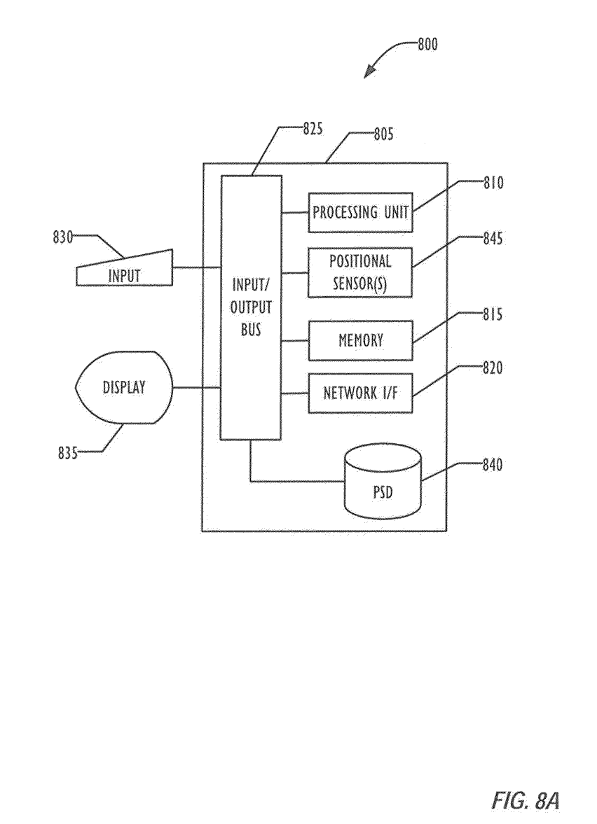

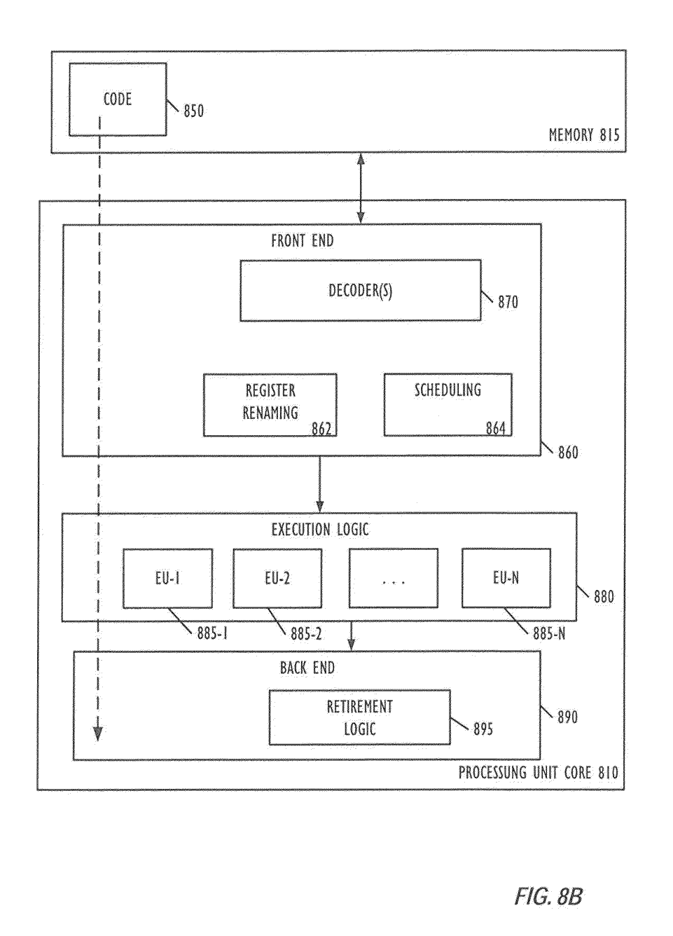

Referring now to FIG. 8A, an example processing device 800 for use in the communication systems described herein according to one embodiment is illustrated in block diagram form. Processing device 800 may serve in, e.g., a mobile phone 102, end user computer 103/112, sync server 105, or a server computer 106-111. Example processing device 800 comprises a system unit 805 which may be optionally connected to an input device 830 (e.g., keyboard, mouse, touch screen, etc.) and display 835. A program storage device (PSD) 840 (sometimes referred to as a hard disk, flash memory, or non-transitory computer readable medium) is included with the system unit 805. Also included with system unit 805 may be a network interface 820 for communication via a network (either cellular or computer) with other mobile and/or embedded devices (not shown). Network interface 820 may be included within system unit 805 or be external to system unit 805. In either case, system unit 805 will be communicatively coupled to network interface 820. Program storage device 840 represents any form of non-volatile storage including, but not limited to, all forms of optical and magnetic memory, including solid-state storage elements, including removable media, and may be included within system unit 805 or be external to system unit 805. Program storage device 840 may be used for storage of software to control system unit 805, data for use by the processing device 800, or both.

System unit 805 may be programmed to perform methods in accordance with this disclosure. System unit 805 comprises one or more processing units, input-output (I/O) bus 825 and memory 815. Access to memory 815 can be accomplished using the communication bus 825. Processing unit 810 may include any programmable controller device including, for example, a mainframe processor, a mobile phone processor, or, as examples, one or more members of the INTEL® ATOM™, INTEL® XEON™, and INTEL® CORE™ processor families from Intel Corporation and the Cortex and ARM processor families from ARM. (INTEL, INTEL ATOM, XEON, and CORE are trademarks of the Intel Corporation. CORTEX is a registered trademark of the ARM Limited Corporation. ARM is a registered trademark of the ARM Limited Company). Memory 815 may include one or more memory modules and comprise random access memory (RAM), read only memory (ROM), programmable read only memory (PROM), programmable read-write memory, and solid-state memory. As also shown in FIG. 8A, system unit 805 may also include one or more positional sensors 845, which may comprise an accelerometer, gyrometer, global positioning system (GPS) device, or the like, and which may be used to track the movement of user client devices.

Referring now to FIG. 8B, a processing unit core 810 is illustrated in further detail, according to one embodiment. Processing unit core 810 may be the core for any type of processor, such as a micro-processor, an embedded processor, a digital signal processor (DSP), a network processor, or other device to execute code. Although only one processing unit core 810 is illustrated in FIG. 8B, a processing element may alternatively include more than one of the processing unit core 810 illustrated in FIG. 8B. Processing unit core 810 may be a single-threaded core or, for at least one embodiment, the processing unit core 810 may be multithreaded, in that, it may include more than one hardware thread context (or “logical processor”) per core.

FIG. 8B also illustrates a memory 815 coupled to the processing unit core 810. The memory 815 may be any of a wide variety of memories (including various layers of memory hierarchy), as are known or otherwise available to those of skill in the art. The memory 815 may include one or more code instruction(s) 850 to be executed by the processing unit core 810. The processing unit core 810 follows a program sequence of instructions indicated by the code 850. Each instruction enters a front end portion 860 and is processed by one or more decoders 870. The decoder may generate as its output a micro operation such as a fixed width micro operation in a predefined format, or may generate other instructions, microinstructions, or control signals which reflect the original code instruction. The front end 860 may also include register renaming logic 862 and scheduling logic 864, which generally allocate resources and queue the operation corresponding to the convert instruction for execution.

The processing unit core 810 is shown including execution logic 880 having a set of execution units 885-1 through 885-N. Some embodiments may include a number of execution units dedicated to specific functions or sets of functions. Other embodiments may include only one execution unit or one execution unit that can perform a particular function. The execution logic 880 performs the operations specified by code instructions.

After completion of execution of the operations specified by the code instructions, back end logic 890 retires the instructions of the code 850. In one embodiment, the processing unit core 810 allows out of order execution but requires in order retirement of instructions. Retirement logic 895 may take a variety of forms as known to those of skill in the art (e.g., re-order buffers or the like). In this manner, the processing unit core 810 is transformed during execution of the code 850, at least in terms of the output generated by the decoder, the hardware registers and tables utilized by the register renaming logic 862, and any registers (not shown) modified by the execution logic 880.

Although not illustrated in FIG. 8B, a processing element may include other elements on chip with the processing unit core 810. For example, a processing element may include memory control logic along with the processing unit core 810. The processing element may include I/O control logic and/or may include I/O control logic integrated with memory control logic. The processing element may also include one or more caches.

### EXAMPLES

Example 1 is a non-transitory computer readable medium that comprises computer executable instructions stored thereon to cause one or more processing units to: obtain, at a centralized server, one or more messages for a first user from each of a first plurality of communications channels, wherein each of the first plurality of communications channels are configured to connect to the centralized server and attempt to maintain a persistent connection to a client associated with the first user; receive, at the centralized server, one or more requests to change a gateway for a particular one of the first plurality of communication channels; and update, by the centralized server, the gateway for the particular one of the first plurality of communication channels according to the one or more requests.

Example 2 includes the subject matter of example 1, wherein at least one of the first plurality of communications channels enters or exits the centralized server via a third party server.

Example 3 includes the subject matter of example 1, wherein at least one of the first plurality of communications channels enters or exits the centralized server via a client.

Example 4 includes the subject matter of example 2, wherein at least one of the first plurality of communications channels enters or exits the centralized server via a client.

Example 5 includes the subject matter of example 1, wherein the client is configured to connect to the centralized server via a socket protocol.

Example 6 includes the subject matter of example 5, wherein the socket protocol comprises a WebSocket protocol.

Example 7 includes the subject matter of example 1, further comprising instructions to store at least one of the one or more messages obtained at the centralized server as a JavaScript Object Notation (JSON) object.

Example 8 includes the subject matter of example 7, wherein the JSON object comprises a plurality of attributes comprising at least one of the following: a message type; a format type; a channel association; a sender association; and a recipient association.

Example 9 includes the subject matter of example 1, wherein at least one of the first plurality of communications channels is configured to connect to the centralized server via a socket protocol.

Example 10 includes the subject matter of example 4, wherein the instructions to update, by the centralized server, the gateway for the particular one of the first plurality of communication channels according to the one or more requests further comprise instructions to: update the particular one of the first plurality of communications channels from entering and exiting the centralized server via a third party server to entering and exiting the centralized server via a client; or update the particular one of the first plurality of communications channels from entering and exiting the centralized server via a client to entering and exiting the centralized server via a third party server.

Example 11 is a system, comprising: a memory; a centralized server; and one or more processing units, communicatively coupled to the memory and the centralized server, wherein the memory stores instructions to configure the one or more processing units to: obtain, at the centralized server, one or more messages for a first user from each of a first plurality of communications channels, wherein each of the first plurality of communications channels are configured to connect to the centralized server and attempt to maintain a persistent connection to a client associated with the first user; receive, at the centralized server, one or more requests to change an gateway device for a particular one of the first plurality of communication channels; and update, by the centralized server, the gateway device for the particular one of the first plurality of communication channels according to the one or more requests.

Example 13 includes the subject matter of example 11, wherein at least one of the first plurality of communications channels enters or exits the centralized server via a third party server.

Example 13 includes the subject matter of example 11, wherein at least one of the first plurality of communications channels enters or exits the centralized server via a client.

Example 14 includes the subject matter of example 12, wherein at least one of the first plurality of communications channels enters or exits the centralized server via a client.

Example 15 includes the subject matter of example 11, wherein the client is configured to connect to the centralized server via a socket protocol.

Example 16 includes the subject matter of example 15, wherein the socket protocol comprises a WebSocket protocol.

Example 17 includes the subject matter of example 11, further comprising instructions to store at least one of the one or more messages obtained at the centralized server as a JavaScript Object Notation (JSON) object.

Example 18 includes the subject matter of example 17, wherein the JSON object comprises a plurality of attributes comprising at least one of the following: a message type; a format type; a channel association; a sender association; and a recipient association.

Example 19 includes the subject matter of example 11, wherein at least one of the first plurality of communications channels is configured to connect to the centralized server via a socket protocol.

Example 20 includes the subject matter of example 14, wherein the instructions to update, by the centralized server, the gateway for the particular one of the first plurality of communication channels according to the one or more requests further comprise instructions to: update the particular one of the first plurality of communications channels from entering and exiting the centralized server via a third party server to entering and exiting the centralized server via a client; or update the particular one of the first plurality of communications channels from entering and exiting the centralized server via a client to entering and exiting the centralized server via a third party server.

Example 21 is a computer-implemented method, comprising: obtaining, at a centralized server, one or more messages for a first user from each of a first plurality of communications channels, wherein each of the first plurality of communications channels are configured to connect to the centralized server and attempt to maintain a persistent connection to a client associated with the first user; receiving, at the centralized server, one or more requests to change an gateway device for a particular one of the first plurality of communication channels; and updating, by the centralized server, the gateway device for the particular one of the first plurality of communication channels according to the one or more requests.

Example 22 includes the subject matter of example 21, further comprising the act of storing at least one of the one or more messages obtained at the centralized server as a JavaScript Object Notation (JSON) object.

Example 23 includes the subject matter of example 22, wherein the JSON object comprises a plurality of attributes comprising at least one of the following: a message type; a format type; a channel association; a sender association; and a recipient association.

Example 24 includes the subject matter of example 21, wherein at least one of the first plurality of communications channels is configured to connect to the centralized server via a socket protocol.

Example 25 includes the subject matter of example 21, wherein the act of updating, by the centralized server, the gateway for the particular one of the first plurality of communication channels according to the one or more requests further comprises performing the act of: updating the particular one of the first plurality of communications channels from entering and exiting the centralized server via a third party server to entering and exiting the centralized server via a client; or updating the particular one of the first plurality of communications channels from entering and exiting the centralized server via a client to entering and exiting the centralized server via a third party server.

Example 26 is a non-transitory computer readable medium comprising computer executable instructions stored thereon to cause one or more processing units to: obtain, at a first device associated with a first user, one or more messages for the first user from each of a first plurality of communications channels, wherein each of the first plurality of communications channels are configured to connect to the first device and attempt to maintain a persistent connection to the first device; receive, at the first device, one or more requests from a second device associated with the first user to send a message from a particular one of the first plurality of communication channels to the second device, wherein the second device is not configured to obtain messages from the particular one of the first plurality of communication channels when it requests the first device to send the message; and send, by the first device, the one or more requested messages from the particular one or more of the first plurality of communication channels to the second device; obtain, at the second device, one or more messages for the first user from the particular one of the first plurality of communication channels; receive, at the second device, one or more requests from the first device to send a message from the particular one of the first plurality of communication channels to the first device, wherein the first device is not configured to obtain messages from the particular one of the first plurality of communication channels when it requests the second device to send the message; and send, by the second device, the one or more requested messages from the particular one or more of the first plurality of communication channels to the first device.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory computer readable medium comprising computer executable instructions stored thereon to cause one or more processing units to:
obtain, at a centralized server, one or more messages for a first user from each of a first plurality of communications channels, wherein each of the first plurality of communications channels are configured to connect to the centralized server and attempt to maintain a persistent connection to a client associated with the first user;
receive, at the centralized server, one or more requests to change a gateway for a particular one of the first plurality of communication channels; and
update, by the centralized server, the gateway for the particular one of the first plurality of communication channels according to the one or more requests.

2. The non-transitory computer readable medium of claim 1, wherein at least one of the first plurality of communications channels enters or exits the centralized server via a third party server.

3. The non-transitory computer readable medium of claim 1, wherein at least one of the first plurality of communications channels enters or exits the centralized server via a client.

4. The non-transitory computer readable medium of claim 2, wherein at least one of the first plurality of communications channels enters or exits the centralized server via a client.

5. The non-transitory computer readable medium of claim 1, wherein the client is configured to connect to the centralized server via a socket protocol.

6. The non-transitory computer readable medium of claim 5, wherein the socket protocol comprises a WebSocket protocol.

7. The non-transitory computer readable medium of claim 1, further comprising instructions to store at least one of the one or more messages obtained at the centralized server as a JavaScript Object Notation (JSON) object.

8. The non-transitory computer readable medium of claim 7, wherein the JSON object comprises a plurality of attributes comprising at least one of the following: a message type; a format type; a channel association; a sender association; and a recipient association.

9. The non-transitory computer readable medium of claim 1, wherein at least one of the first plurality of communications channels is configured to connect to the centralized server via a socket protocol.

10. The non-transitory computer readable medium of claim 4, wherein the instructions to update, by the centralized server, the gateway for the particular one of the first plurality of communication channels according to the one or more requests further comprise instructions to: update the particular one of the first plurality of communications channels from entering and exiting the centralized server via a third party server to entering and exiting the centralized server via a client; or update the particular one of the first plurality of communications channels from entering and exiting the centralized server via a client to entering and exiting the centralized server via a third party server.

11. A system, comprising:
a memory;
a centralized server; and
one or more processing units, communicatively coupled to the memory and the centralized server, wherein the memory stores instructions to configure the one or more processing units to:
obtain, at the centralized server, one or more messages for a first user from each of a first plurality of communications channels, wherein each of the first plurality of communications channels are configured to connect to the centralized server and attempt to maintain a persistent connection to a client associated with the first user;
receive, at the centralized server, one or more requests to change an gateway device for a particular one of the first plurality of communication channels; and
update, by the centralized server, the gateway device for the particular one of the first plurality of communication channels according to the one or more requests.

12. The system of claim 11, wherein at least one of the first plurality of communications channels enters or exits the centralized server via a third party server.

13. The system of claim 11, wherein at least one of the first plurality of communications channels enters or exits the centralized server via a client.

14. The system of claim 12, wherein at least one of the first plurality of communications channels enters or exits the centralized server via a client.

15. The system of claim 11, wherein the client is configured to connect to the centralized server via a socket protocol.

16. The system of claim 15, wherein the socket protocol comprises a WebSocket protocol.

17. The system of claim 11, further comprising instructions to store at least one of the one or more messages obtained at the centralized server as a JavaScript Object Notation (JSON) object.

18. The system of claim 17, wherein the JSON object comprises a plurality of attributes comprising at least one of the following: a message type; a format type; a channel association; a sender association; and a recipient association.

19. The system of claim 11, wherein at least one of the first plurality of communications channels is configured to connect to the centralized server via a socket protocol.

20. The system of claim 14, wherein the instructions to update, by the centralized server, the gateway for the particular one of the first plurality of communication channels according to the one or more requests further comprise instructions to: update the particular one of the first plurality of communications channels from entering and exiting the centralized server via a third party server to entering and exiting the centralized server via a client; or update the particular one of the first plurality of communications channels from entering and exiting the centralized server via a client to entering and exiting the centralized server via a third party server.

21. A computer-implemented method, comprising:
obtaining, at a centralized server, one or more messages for a first user from each of a first plurality of communications channels, wherein each of the first plurality of communications channels are configured to connect to the centralized server and attempt to maintain a persistent connection to a client associated with the first user;
receiving, at the centralized server, one or more requests to change an gateway device for a particular one of the first plurality of communication channels; and
updating, by the centralized server, the gateway device for the particular one of the first plurality of communication channels according to the one or more requests.

22. The method of claim 21, further comprising the act of storing at least one of the one or more messages obtained at the centralized server as a JavaScript Object Notation (JSON) object.

23. The method of claim 22, wherein the JSON object comprises a plurality of attributes comprising at least one of the following: a message type; a format type; a channel association; a sender association; and a recipient association.

24. The method of claim 21, wherein at least one of the first plurality of communications channels is configured to connect to the centralized server via a socket protocol.

25. The method of claim 21, wherein the act of updating, by the centralized server, the gateway for the particular one of the first plurality of communication channels according to the one or more requests further comprises performing the act of: updating the particular one of the first plurality of communications channels from entering and exiting the centralized server via a third party server to entering and exiting the centralized server via a client; or updating the particular one of the first plurality of communications channels from entering and exiting the centralized server via a client to entering and exiting the centralized server via a third party server.

26. A non-transitory computer readable medium comprising computer executable instructions stored thereon to cause one or more processing units to:
obtain, at a first device associated with a first user, one or more messages for the first user from each of a first plurality of communications channels, wherein each of the first plurality of communications channels are configured to connect to the first device and attempt to maintain a persistent connection to the first device;
receive, at the first device, one or more requests from a second device associated with the first user to send a message from a particular one of the first plurality of communication channels to the second device, wherein the second device is not configured to obtain messages from the particular one of the first plurality of communication channels when it requests the first device to send the message;
send, by the first device, the one or more requested messages from the particular one of the first plurality of communication channels to the second device;
obtain, at the second device, one or more messages for the first user from the particular one of the first plurality of communication channels;
receive, at the second device, one or more requests from the first device to send a message from the particular one of the first plurality of communication channels to the first device, wherein the first device is not configured to obtain messages from the particular one of the first plurality of communication channels when it requests the second device to send the message; and
send, by the second device, the one or more requested messages from the particular one or more of the first plurality of communication channels to the first device.
